(19) United States
(12) Patent Application Publication
(10) Pub. No.: US 2011/0036699 A1
(43) Pub. Date: Feb. 17, 2011

(54) Switch with automatic shut_off feature and override feature

(76) Inventor: Charles Earnest Daffin, III, Tallahassee, FL (US)

Correspondence Address: CHARLES ERNEST DAFFIN III, 5018 BRADFORDVILLE RD, TALLAHASSEE, FL, 32309, US

(21) Appl. No.: 12/583,076

(22) Filed: Aug. 14, 2009

(51) Int. Cl. H01H 43/10

(52) U.S. Cl. 200/38 A; 315/362

(57) ABSTRACT

A switch having an automatic shut-off feature which turns off the switch after a defined period of time has elapsed. The invention has additional override features which allow the user to selectively override the automatic shut-off feature. The override feature can be a simple button or switch which the user can manually actuate. The override feature can also be remotely controlled using a hard-wired control line tied to an auxiliary panel, or a wireless control device such as a radio or ultrasonic link.

### BACKGROUND OF THE INVENTION

1. Field of the Invention

This invention relates generally to the field of electrical control devices. More particularly, the present invention comprises a switch for light, fan or any switched controlled device, having an automatic shut-off feature and an override feature for modifying or turning off the shut-off feature.

2. Description of the Related Art

The concept of a switch having an automatic shut-off feature is described and claimed by the present inventor in U.S. Pat. No. 7,525,058 (2009) to Daffin, which is hereby incorporated by reference. Such a switch preferably fits within the prior art switch boxes so that they may be retrofitted into existing installations and easily installed using existing equipment.

The switch disclosed in the Daffin '058 patent is effective for its intended purpose. However, there are instances when the automatic shut-off feature is unwanted. Some users may wish to override the shut-off feature in certain circumstances or—depending on the user's preference—in all circumstances. It is therefore desirable to produce a light switch having a shut-off feature having other features which also allow the shut-off feature to be modified or turned off altogether. The present invention provides these features, as well as others.

### BRIEF SUMMARY OF THE PRESENT INVENTION

The present invention comprises a switch having an automatic shut-off feature which turns off the switch after a defined period of time has elapsed. The invention has additional override features which allow the user to selectively override the automatic shut-off feature. The override feature can be a simple button or switch which the user can manually or remotely actuate. The override feature can also be remotely controlled using a hard-wired control line tied to an auxiliary panel, or a wireless control device such as a radio, ultrasonic link or wave frequency.

In some instances the override feature may be automated. Preferred embodiments include human presence sensors, such as heat, motion detectors or future detection device(s). These sensors detect the presence of an occupant in a room and suppress the automatic shut-off feature for the lights in that room until the occupant departs.

### BRIEF DESCRIPTION OF THE SEVERAL VIEWS OF THE DRAWINGS

FIG. 1 is an exploded perspective view, showing a switch assembly made according to the present invention being installed in a prior art switch box.

FIG. 2 is a perspective view, showing the opposite side of the switch assembly of

FIG. 3 is a detailed perspective view, showing the provision of indicator and override features on the switch assembly.

FIG. 4 is a schematic view, showing some of the internal operating features of the present invention.

FIG. 5 is a perspective view, showing dial setting.

FIG. 6 is a perspective view, showing “override controls” and time set controls.

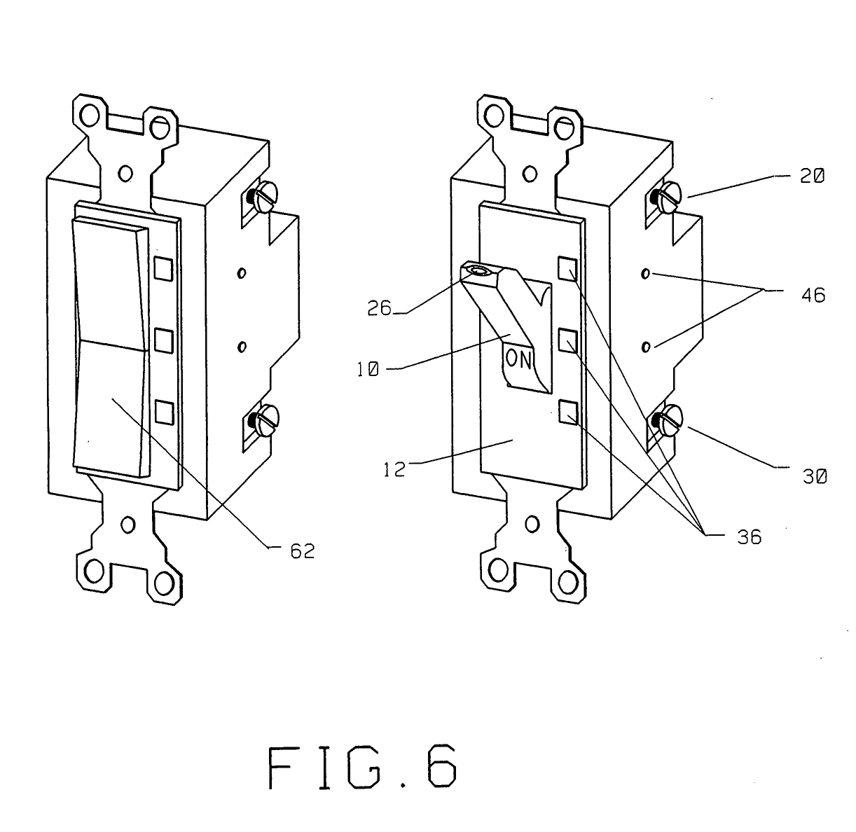

FIG. 7 is a schematic view, showing an integrated application system with invention and controlled device. Which is a light in this example application.

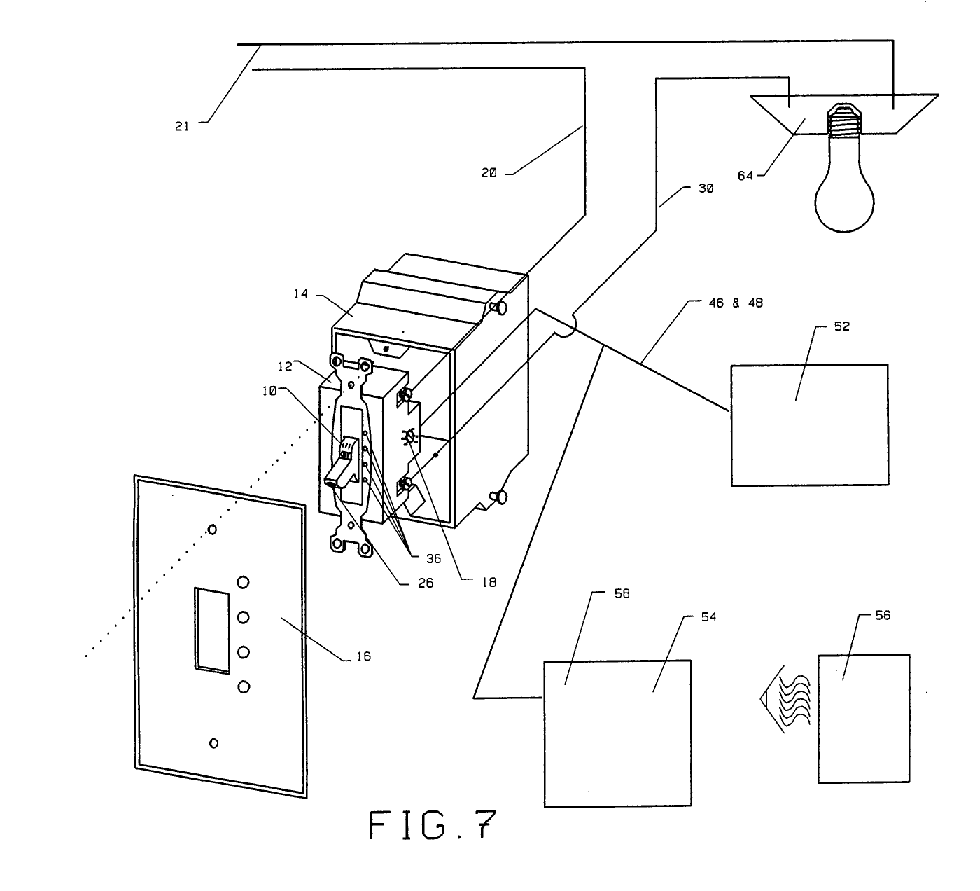

REFERENCE NUMERALS IN THE DRAWINGS

| | | | |
|---|---|---|---|
| 10 | toggle switch | 12 | switch assembly |
| 14 | switch box | 16 | cover plate |
| 18 | timer control knob | 20 | black wire connection |
| 21 | white wire connection | 26 | illuminated button |
| 28 | recessed switch | 30 | electrical load |
| 32 | power relay | 34 | transformer/rectifier |
| 36 | override control(s) | 38 | timer/controller |
| 40 | LED controller | 42 | pulse timer |
| 44 | LED | 46 | override control line |
| 48 | indicator control line | 50 | remote input line |
| 52 | remote panel | 54 | receiver |
| 56 | wireless remote | 58 | occupancy sensor |
| 60 | slot | 62 | rocker switch |
| 64 | controlled device | | |

### DETAILED DESCRIPTION OF THE INVENTION

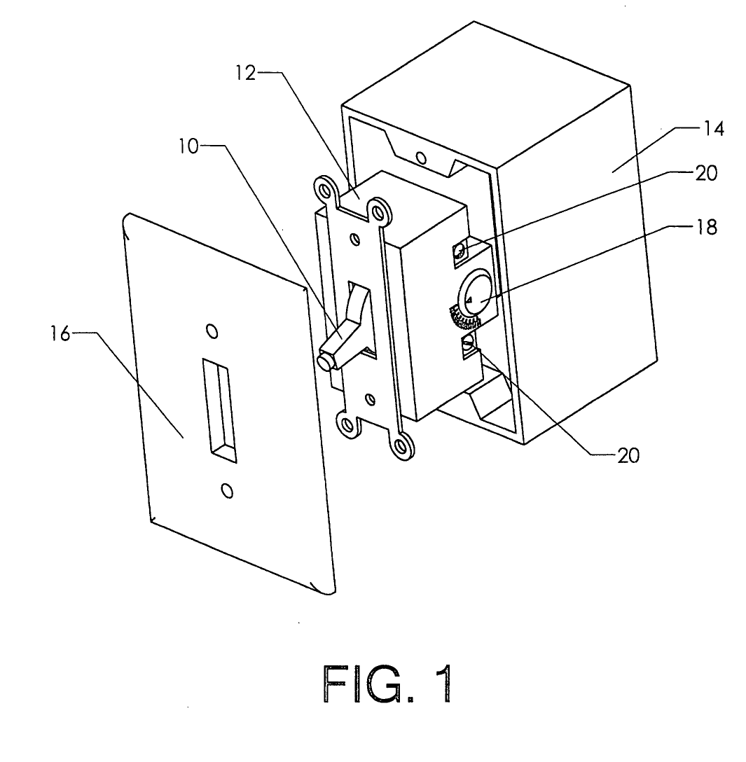

FIG. 1 shows a prior art switch box 14 and associated cover plate 16. The switch box is conventionally mounted to a wall stud. Its opening is then surrounded by wall covering. A conventional light switch would then be installed in the opening and cover plate 16 would be installed over the switch. The present invention—designated as switch assembly 12 in the view—is preferably sized to be substituted for the prior art switch so that the existing hardware can still be used.

Switch assembly 12 includes toggle switch 10 which a user can employ to control a light or other device. The toggle switch is conventionally “off” when toggled down and “on” when toggled up. Those skilled in the art will know that many different typed of user-actuated switches are known in the art. Examples include rocker switches, push-button switches, and capacitive switches which do not move and are actuated instead by skin contact. Any type of user-actuated switch can be selected for switch assembly 12, so the toggle switch illustrated should be viewed as exemplary.

The switch assembly includes an automatic shut-off feature. When the user flips toggle switch 10 to the “on” position, a timer function is started. When a predetermined amount of time has elapsed, the automatic-shut-off feature shuts off the light switch. The shut-off feature can be a mechanical device such as a solenoid (which would physically propel toggle switch 10 back to the “off” position), an electrical device (such as a control relay), or some combination of the two.

The predetermined amount of time which the light switch remains on is preferably variable. Timer control knob 18 may be provided so that the user can easily adjust the amount of time the light will stay on (such as between 1 minute and 10 hours, for example). Or fixed time could be built into individual switches. Push buttons and other user-interface features could be substituted for the timer control knob and the particular approach taken is not significant to the present invention.

Two black wire connections 20 are provided on the side of the switch assembly facing the viewer in FIG. 1. These are shown as screw terminals but may be of any known type. Those skilled in the art will know that in residential wiring the “black wire” is the hot wire which typically carries 110 VAC. The switch assembly makes or breaks a connection between the two black wire connections 20 (thereby establishing and breaking the circuit).

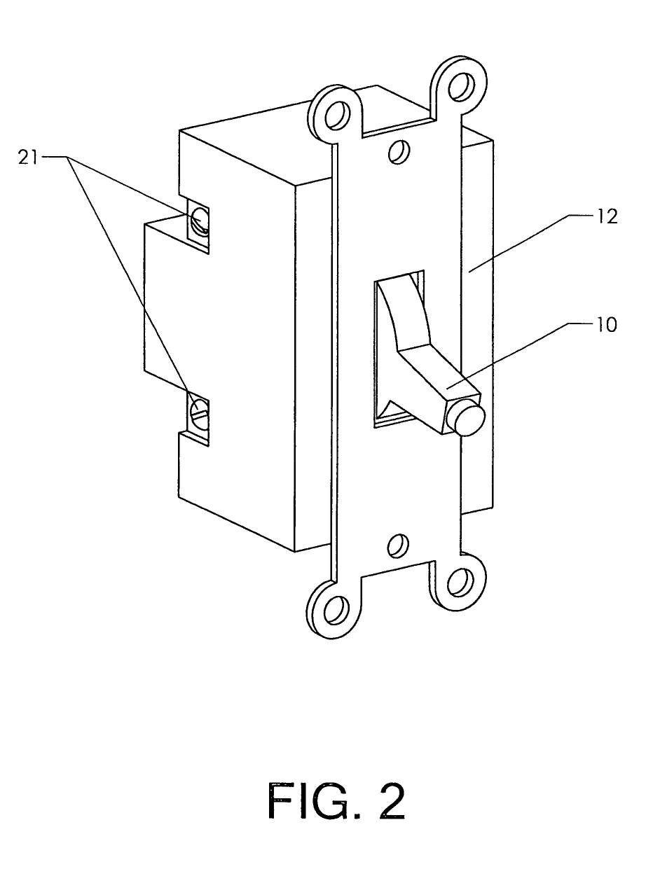

FIG. 2 shows a perspective view of the opposite side of switch assembly 12. In some embodiments it is desirable to provide a complete AC circuit connection to the switch assembly. This would include the black “hot” wire and the white “neutral” wire. Thus, a white wire connection 21 is preferably provided (two or more connections may optionally be provided).

In operation, a user flips toggle switch 10 to the “on” position, thereby providing power to the electrical load controlled by the switch assembly. Flipping the switch “on” starts the timing function. When the predetermined amount of time expires, the automatic shut-off feature breaks the connection between the two black wire connections 20 (again this may be done by physically moving the toggle switch or using some other device such as a power transistor, mechanical device, clock, digital or power relay). If the switch is controlling a light, the light will go dark.

At this point it is preferable to provide the user with some type of indication that the automatic shut-off feature has shut down the switch (otherwise the user may assume that a breaker has tripped or the light bulb has failed). An indicator can assume many forms. One example would be a “flag” type of display such as used on circuit breakers. However, because the room in which the switch is located will likely be dark, it is preferable to provide an illuminated indicator, such as a LED.

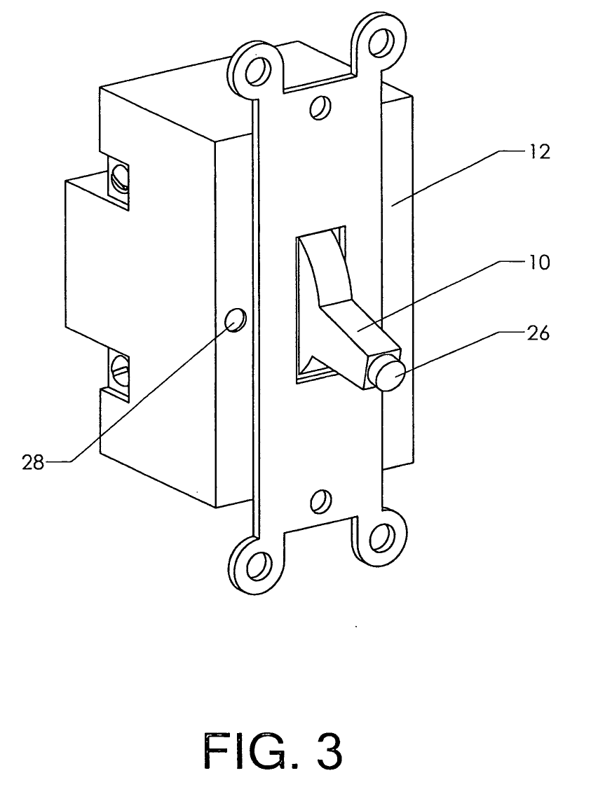

FIG. 3 shows a detailed perspective view of the toggle switch 10. In this embodiment, illuminated button 26 is provided on the toggle switch's tip. The button is molded out of transparent or translucent material and a light emitting diode (“LED”) is contained within. When the automatic shut-off feature is actuated, the LED is illuminated. Thus, a user standing in a suddenly darkened room will immediately notice the LED.

An LED controller can be used to selectively pulse the LED or provide other visual effects. As an example, immediately after the actuation of the automatic shut-off feature, the LED could be brightly pulsed at a rapid rate. This would immediately attract the attention of any person in the room. Of course, it is likely that no one will be in the room and as the switch is designed in part to conserve energy, it makes sense to decrease the intensity and frequency of the LED flashes. After pulsing brightly for 30 seconds the LED controller might reduce the intensity and reduce the frequency to one flash every two seconds.

The present invention recognizes that the automatic shut-off feature can at times be an inconvenience. An override function is provided to address this problem. When a user actuates the override function, the automatic shut-off feature is discontinued. As one example, illuminated button 26 can be a combination indicator and override actuation button. When the user sees the LED flashing, he or she can walk over and press illuminated button 26. This will discontinue the automatic shut-off feature and allow the light switch to be operated normally.

The actual effect of pressing the illuminated button will depend upon the type of automatic shut-off feature used. While it is impossible to go through every potential example, two quick examples may aid the reader's understanding: (1) If the automatic shut-off includes a mechanical feature that actually moves toggle switch 10 back to the “off” position, then the user will need to press illuminated button 26 and then physically flip the toggle switch to the “on” position; (2) If the automatic shut-off feature interrupts power without moving the toggle switch, then the user pressing illuminated button 26 would cause a light controlled by the switch to immediately illuminate.

The override function can be actuated in an endless variety of ways and the invention is not limited to any particular embodiments. FIG. 3 shows an alternate embodiment labeled as recessed switch 28. A small hole in the cover plate is provided which aligns with this recessed switch. A small and pointed object such as a pencil or pen point can be used to actuate recessed switch 28 and thereby actuate the override function.

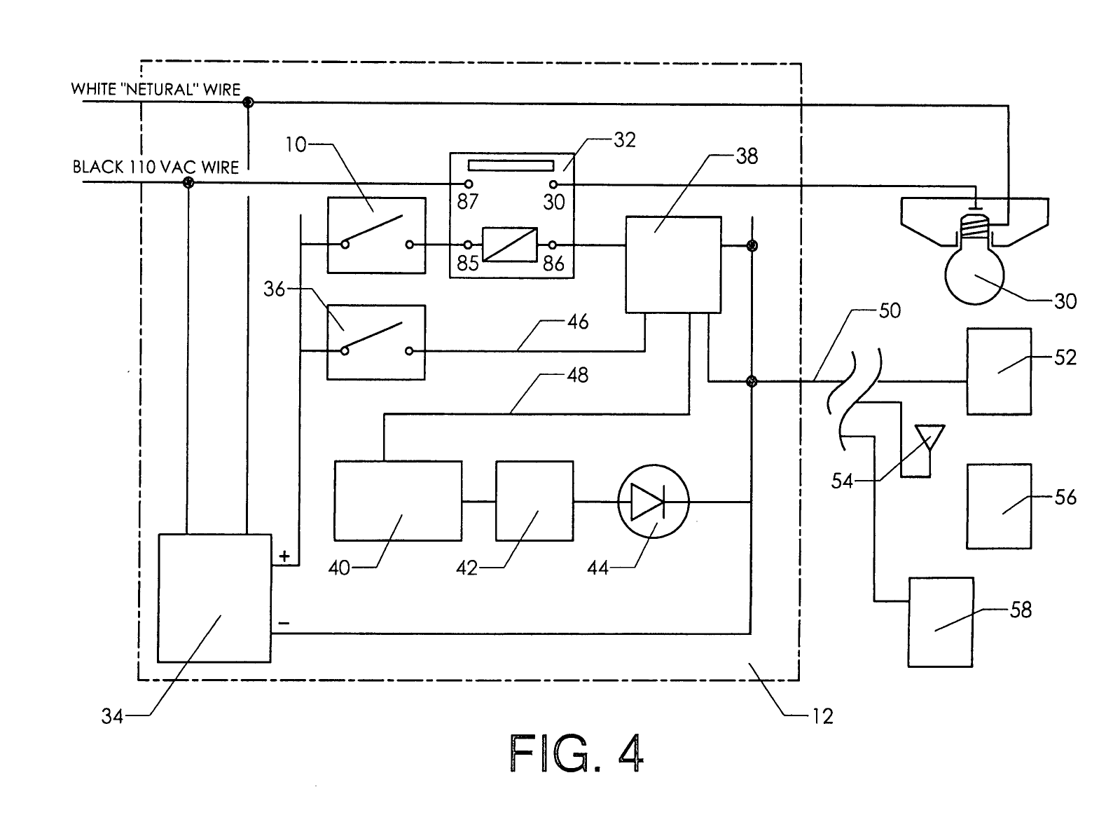

FIG. 4 shows an exemplary circuit for implementing the proposed invention. Those skilled in the art will know that the invention could be implemented in a virtually endless variety of ways, using an equally various list of components. Switch assembly 12 preferably includes everything within the dashed lines. The version of FIG. 4 uses power relay 32 to make or break the AC circuit to electrical load 30 (in this case a light bulb). The power relay terminals are labeled according to convention (85/86 and 87/30). Terminals 85 and 86 are the low current “control” side of the relay. Terminals 87 and 30 are the high current “power” side of the relay. Making or breaking the circuit flowing through terminals 85 and 86 makes and breaks the high-current circuit flowing through terminals 87 and 30.

This embodiment uses low voltage direct current for switching and control functions. The low voltage DC is conveniently produced by installing transformer/rectifier 34 across the white and black AC wires. This steps down the voltage and preferably removes most of the AC wave to produce a fairly smooth DC output. As shown, the DC output has a positive rail and a negative rail.

Toggle switch 10 is installed across the DC rails in series with power relay 32. Timer/controller 38 is also installed in series in the same current loop. When the user closes toggle switch 10, the power relay provides AC current to electrical load 30. This action also starts timer/controller 38. The timer controller “counts” until a predetermined amount of time has passed. It then opens the circuit passing through terminals 85 and 86. This—in turn—opens the circuit passing through terminals 87 and 30.

Timer/controller 38 actuates indicator control line 48 which—in this embodiment—provides voltage to LED controller 40. The LED controller and pulse timer 42 then begin pulsing LED 44 (which may be within illuminated button 26 or at some other visible location).

If a user then closes override switch 36, override control line 46 provides voltage to another terminal on timer/controller 38. This “informs” the timer/controller that the override function has been activated. The timer/controller then (1) shuts down the voltage on indicator control line 48; and (2) reestablishes the circuit across terminals 85 and 86 so that electrical load 30 is switched back on. In this embodiment, the toggle switch is not physically moved by the automatic shut-off feature. Thus, when the override function is actuated the light will be immediately turned back on.

In some embodiments the override function will not be actuated by a device mounted directly on the switch assembly. Remote input line 50 to timer/controller 38 is provided for this purpose. As one example, a remote lighting control panel 52 may be provided at a convenient location in the house. This panel could control the override function on two or more switch assemblies. Actuating a feature on the remote panel would supply voltage to remote input line 52 and this would cause timer/controller 38 to actuate the override function as described previously.

Other control means can be used to remotely activate the override function. Radio frequency receiver 54 can be used to create a signal on remote input line 50 when a coded message is sent from wireless remote 56.

Still another approach is to provide one or more occupancy sensors 58. This component is any sensor capable of detecting the presence of a person in an area. For example, ultrasonic motion detectors or infra red body heat detectors could be used. In the event that an occupant is detected, a voltage is applied to remote input line 50 and this automatically actuates the override function. Thus, if an occupant is present in a room controlled by a switch, then the override function can be automatically activated.

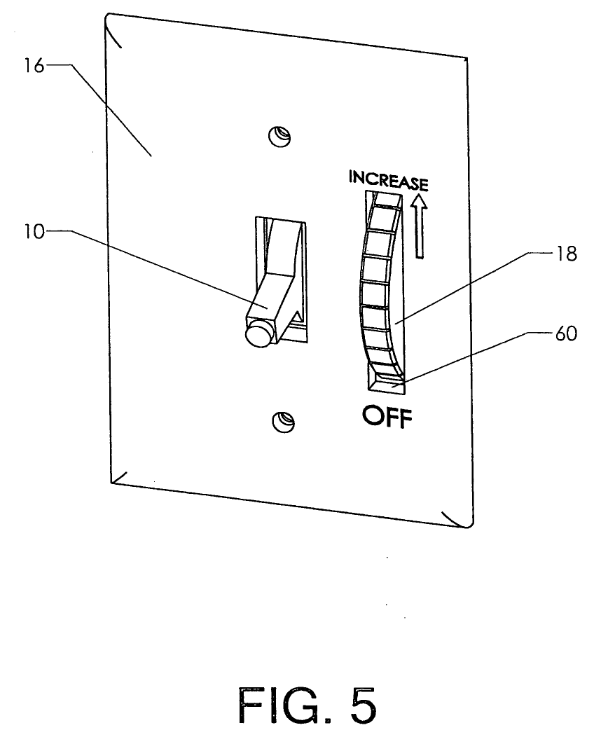

Many other variations are possible within the scope of the invention. For example, it may be desirable to provide access to the timing function without removing the cover plate. FIG. 5 shows a perspective view of such an embodiment. Timer control knob 18 is made larger and protrudes through slot 60 in cover plate 16. The user may easily increase the predetermined time by rotating the timer control knob as shown. The override function can also be incorporated into the timer control knob by rotating the exposed portion downward to the “off” position.

Although the preceding descriptions contain significant detail they should not be viewed as limiting the invention but rather as providing examples of the preferred embodiments of the invention. As a first example, the override function could be actuated by other suitable means, such as switching the toggle switch on and off three times in three seconds. As a second example, the timer could be a mechanical timer or a digital “counter.” Accordingly, the scope of the invention should be determined by the following claims, rather than the examples given.

Having described my invention, I claim:

1. A switch assembly allowing a user to selectively apply electrical current to a device. Such as a light, fan or other, comprising:
a. a mechanical switch movable between an off position and an on position;
b. an automatic shut-off function, including
i. a detecting device for determining when said mechanical switch is moved to said on position;
ii. a timer for timing the length of time said mechanical switch remains in said on position;
iii. a shut-off device for shutting off said electrical current when said
length of time said mechanical switch has remained in said on position exceeds a defined length of time; and
c. an override function, allowing said user to selectively turn off said automatic shut-off function.

2. A switch assembly as recited in claim 1, wherein said override function includes a user-actuated switch, whereby said user turns off said override function.

3. A switch assembly as recited in claim 1, further comprising a visual indicator configured to indicate to said user that said automatic shut-off function has been actuated.

4. A switch with automatic turn off for a device, such as light, fan or other, that turns off after determined period of time. Also incorporating pre existing or future devices such as, remote or built-in motion sensor, PIR or Black Body Radiation Detector or future “human detectors” yet to be developed.

5. A switch with automatic turn off for a device, such as light, fan or other, that turns off after predetermined period of time where: Time set by screwdriver, hand or other tool. Could be manufactured at set times as 5 minutes+/−, 30 minutes+/−any times 1-8 hours. Can have built in “override”, when activated, would change “turn off” time to longer period. Once switch goes off, would go back to original pre set time. Could have built in 24 hour clock. Once turned on/off, will turned on/off at the set clock day/night time.

6. A light switch assembly as recited in claim 1 wherein:
a. said defined length of time is set by a timer control knob; and
b. said timer control knob can or cannot (Owner option) be adjusted without removing a cover plate covering said light switch assembly.

7. Optional—All turn-on/off and sensor controls can be installed into front of switch or switch cover plate instead of behind, beside or inside switch.

8. A switch assembly allowing a user to selectively apply electrical current or wave frequency to a device, comprising:
a. a mechanical switch movable between an off position and an on position;
b. an automatic shut-off function, including
i. a timer which cycles on when said mechanical switch is moved from said off position to said on position,
ii. a shut-off device for shutting off said electrical current when said timer exceeds a defined length of time; and
c. an override switch allowing a user to selectively suspend said automatic shut-off function.

9. A switch assembly as recited in claim 8, wherein said override function includes a user-actuated switch, whereby said user turns off said override function.

10. A switch assembly as recited in claim 8, further comprising a visual indicator configured to indicate to said user that said automatic shut-off function has been actuated.

11. A switch assembly as recited in claim 8, further comprising:
a. a user-actuated switch, whereby said user can turn off said override function; and
b. a visual indicator configured to indicate to said user that said automatic shut-off function has been actuated.

12. A switch assembly as recited in claim 11, wherein said visual indicator is located proximate said user-actuated switch.

13. A switch assembly as recited in claim 8 wherein:
a. said defined length of time is set by a timer control knob; and
b. said timer control knob can be adjusted without removing a cover plate covering said light switch assembly.

14. A assembly as recited in claim 13, wherein said timer control knob can also be used to select said override function.

15. A switch assembly allowing a user to selectively apply electrical current to a light/device/load, comprising:
a. a mechanical switch movable between an off position and an on position;
b. an automatic shut-off function, including
i. a timer which cycles on when said mechanical switch is moved from said off position to said on position,
ii. a power relay having a high-current line attached to said light and a low-current line used to control said high-current line, said low-current line being connected to said mechanical switch;
iii. a timer/controller connected to said low-current line, said timer/controller being configured to open the circuit of said low-current line after said mechanical switch has been in said on position beyond a defined length of time; and
c. an override switch allowing a user to selectively suspend said automatic shut-off function.

16. A switch assembly as recited in claim 15, wherein said override function includes a user-actuated switch, whereby said user turns off said override function.

17. A switch assembly as recited in claim 15, further comprising a visual indicator configured to indicate to said user that said automatic shut-off function has been actuated.

18. A switch assembly as recited in claim 15, further comprising:
a. a user-actuated switch, whereby said user can turn off said override function; and
b. a visual indicator configured to indicate to said user that said automatic shut-off function has been actuated.

19. A switch assembly as recited in claim 15 wherein:
a. said defined length of time is set by a timer control knob; and
b. said timer control knob can be adjusted without removing a cover plate covering said light switch assembly.

20. A light/device/load assembly as recited in claim 19, wherein said timer control knob can also be used to select said override function.
